(19) United States
(12) Patent Application Publication
(10) Pub. No.: US 2011/0202561 A1
(43) Pub. Date: Aug. 18, 2011

(54) SYSTEM AND METHOD FOR PROVIDING AN ADJUSTMENT VALUE FOR KEYWORDS RETRIEVED FROM A DATA SOURCE AND ADJUSTING AN AVM VALUE BASED ON THE ADJUSTMENT VALUE

(76) Inventors: Benjamin C. Graboske, Santa Ana, CA (US); Robert L. Walker, Tustin, CA (US)

(21) Appl. No.: 12/944,969

(22) Filed: Nov. 12, 2010

Related U.S. Application Data
(60) Provisional application No. 61/260,657, filed on Nov. 12, 2009.

(51) Int. Cl. G06F 17/30

(52) U.S. Cl. 707/776; 707/769; 707/E17.014

(57) ABSTRACT

The invention discloses a system for adjusting an automated valuation model (AVM) value. The system includes a property data source for receiving property data for a property, a data mining module for searching the property data for keywords with corresponding values, and a data matching module for recognizing the keywords, for determining an adjustment value based on the corresponding values, for receiving an AVM value representing an estimated value of the property, and for obtaining an adjusted AVM value based on the AVM value and the adjustment value.

### CLAIM OF BENEFIT UNDER 35 U.S.C. & 119

This application claims priority to and the benefit of U.S. Provisional Application No. 61/260,657, filed Nov. 12, 2009, which is assigned to the assignee hereof and hereby expressly incorporated by reference herein.

### BACKGROUND

1. Field

The present invention relates to real estate valuations and more specifically to a method and apparatus for systematically improving valuations provided by an automated valuation model (AVM).

2. Background

Real estate valuations are more often being completed using advanced computer algorithms based on mathematical modeling and information received from databases. These algorithms are called automated valuation models (AVMs). These AVMs are useful in providing estimates of value for real property for several reasons. Most notably, they are typically substantially less expensive than an appraisal. Additionally, they are much faster, usually only requiring a matter of seconds or at most minutes before they are complete. Finally, these AVMs are fairly accurate estimates of values for properties. For these and other reasons, AVMs are being used more frequently in real estate valuations. It is important that the estimated value for the property be accurate as the value is relied on by banks and other financial institutions in making financial decisions. Therefore, there exists a need in the art for an invention which is useful and systematic for improving the accuracy of AVMs.

### SUMMARY

The invention discloses systems and methods for adjusting an automated valuation model (AVM) value. In one embodiment, the system includes a property data source for receiving property data for a property, a data mining module for searching the property data for keywords with corresponding values, and a data matching module for recognizing the keywords, for determining an adjustment value based on the corresponding values, for receiving an AVM value representing an estimated value of the property, and for obtaining an adjusted AVM value based on the AVM value and the adjustment value.

### BRIEF DESCRIPTION OF THE DRAWINGS

FIG. 1 is a portion of a Multiple Listing Service (MLS) listing of an exemplary residential property located at 1234 Avalon Street in Santa Ana, Calif. 92701 in accordance with an embodiment of the invention;

FIG. 2 is a data mining system used to provide an adjustment value based on or for one or more keywords retrieved from one or more property data sources (e.g., a database) and adjusting an automated valuation model (AVM) value based on the adjustment value in accordance with an embodiment of the invention; and

FIG. 3 is a flow chart showing a method for providing an adjustment value based on or for one or more keywords retrieved from one or more property data sources (e.g., a database) and adjusting an automated valuation model (AVM) value based on the adjustment value in accordance with an embodiment of the invention.

### DETAILED DESCRIPTION

Conventional AVMs do not consider using keywords in determining an estimated value for a property. In one embodiment, conventional AVMs can be improved by searching a database for a single word or a phrase (referred to in this application as “keywords”) which can affect an estimated value for a property. The keywords are used to determine an adjustment value and adjust the estimated value of the property by the adjustment value upon finding a match for the keywords.

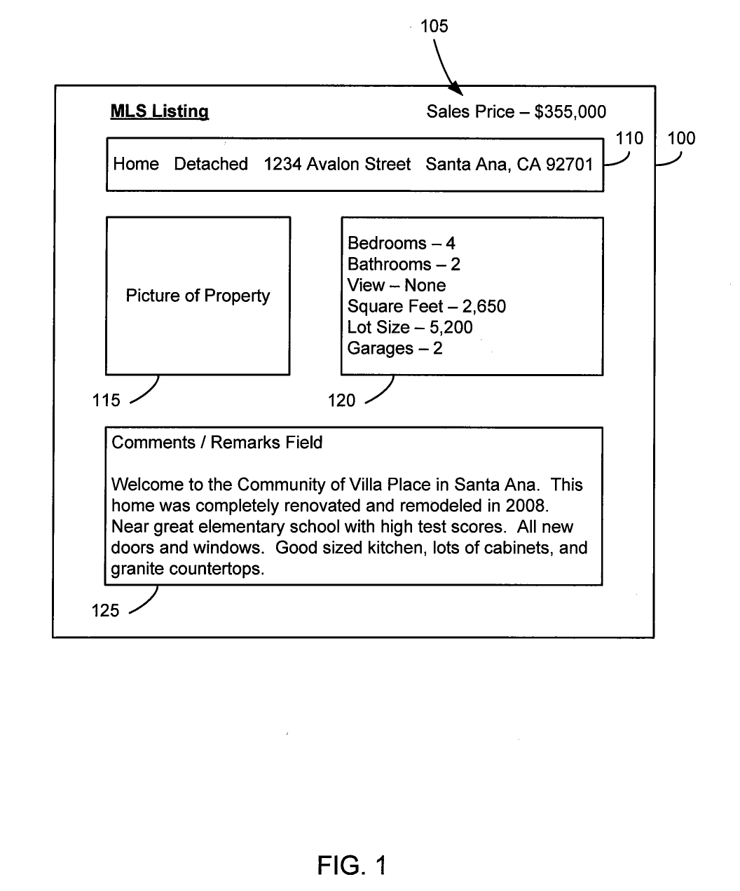

FIG. 1 is a portion of a Multiple Listing Service (MLS) listing 100 of an exemplary residential property located at 1234 Avalon Street in Santa Ana, Calif. 92701. The MLS listing 100 may include one or more properties. Buyers of residential and commercial real estate generally search and review MLS listings to locate particular residential and commercial properties of interest. That is, the MLS listings provide a listing of a number of different properties that satisfy a predetermined criteria input by a user. For example, a user may want to search for all properties within a particular city or zip code so the user would input this information and then perform a search for all properties satisfying the criteria. Once the search is completed and a list is displayed, the user may select a particular listing to view.

FIG. 1 shows a selected MLS listing 100. The MLS listing 100 provides an address field 110 indicating an address of the property of interest, a sales price 105 for the property identified in the address field 110, a picture 115 of the property, a property details field 120, a comments or remarks field 125, as well as other details about the property. The property details field 120 includes detailed property information such as number of bedrooms, number of bathrooms, views, approximate square feet of the property, approximate lot size, and number of garages. In many instances, a real estate professional inputs comments or remarks into a comments/remarks field 125 describing further details of the property. In one embodiment, the comments/remarks field 125 generally includes additional information about the property not found in the property details field 120.

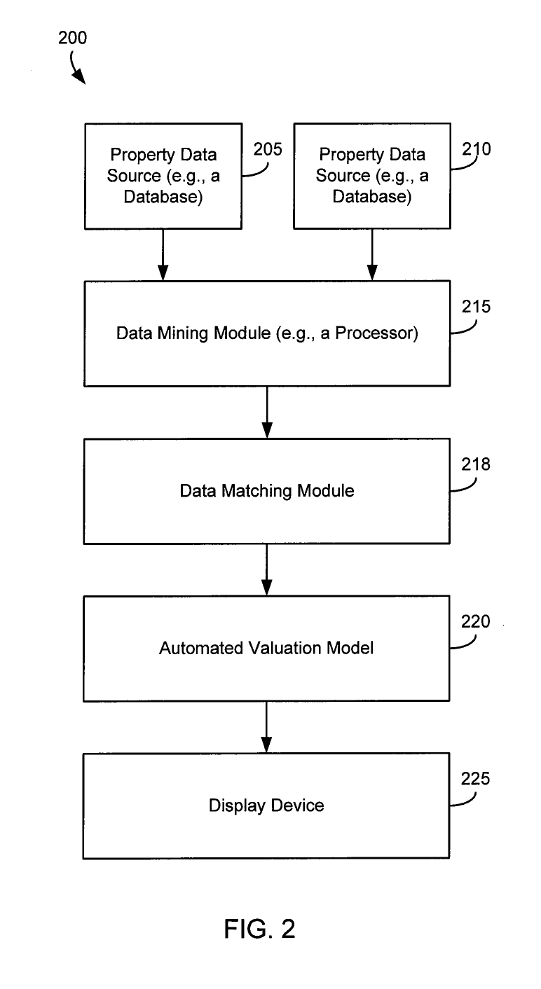

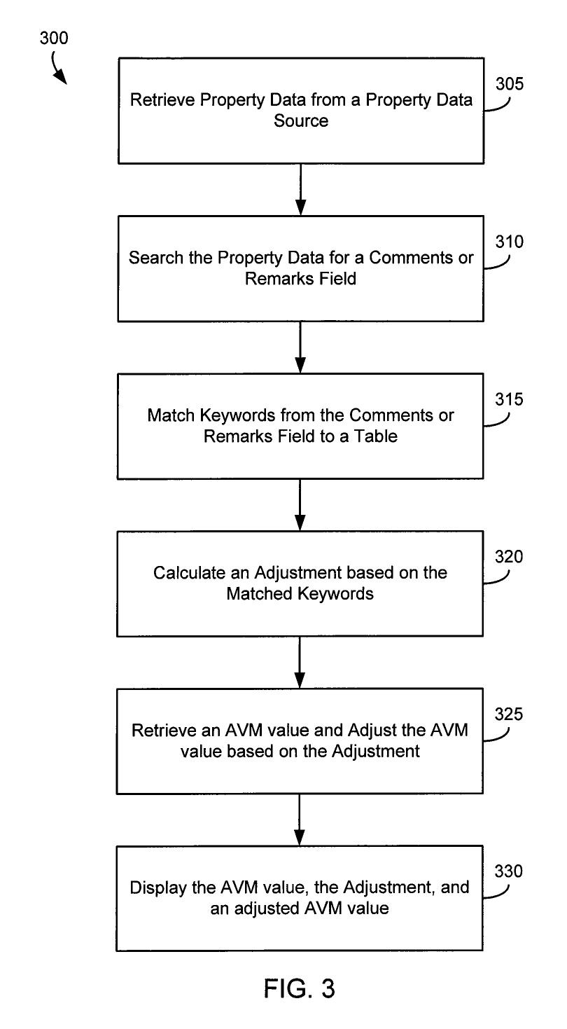

FIG. 2 is a data mining system 200 and FIG. 3 is a method 300 for providing an adjustment value based on or for one or more keywords retrieved from one or more property data sources 205 and 210 (e.g., a database) and adjusting an automated valuation model (AVM) value based on the adjustment value. At step 305, a data mining module 215 (e.g., a processor) retrieves property data from the one or more property data sources 205 and 210. As an example, the property data may be MLS listing data and the property data sources 205 and 210 may be public or private databases that include the MLS listing data for a number of residential and commercial properties. The property data retrieved may be for one or more properties.

The data mining module 215 may search the property data for a comments or remarks field 125 (step 310) and a data matching module 218 (e.g., a processor) may extract or match keywords from the property data using a table (step 315). The table may include specific keywords to look for in the comments or remarks field 125 that are useful to adjust (i.e., increase or decrease) the property value. The table may be part of the data matching module 218.

| Keywords | Relative Difference Value | Percentage Value |
|---|---|---|
| Fixer-Upper or Needs | −$40,000 | −20% |
| Work | | |
| Granite | +$10,000 | +5% |
| Renovated or Remodeled | +$20,000 | +10% |
| New Doors or Windows | +$20,000 | +10% |
| Pool or Spa | +$10,000 | +5% |

As an example, the data mining module 215 searches the comments or remarks field 125 and retrieves the data in the comments or remarks field 125. The data matching module 218 finds three keywords, in this example, from the comments or remarks field 125 that match the table (i.e., “Granite,” “Renovated or Remodeled,” and “New Doors or Windows”). For example, at least one of the keywords “Renovated or Remodeled” is in the comments or remarks field 125, such that a relative difference value of +$20,000 and a percentage value of +10% can be used as part of one or more adjustment values. The data mining module 215 and/or the data matching module 218 calculates the one or more adjustment values (e.g., the addition of the relative difference values ($50,000), the addition of the percentage values (25%), etc.) based on the search and matches and forwards the adjustment value to the AVM 220 for adjustment to the property value (step 320). The AVM 220 retrieves an AVM value (e.g., $290,000) of the property from a database or calculates an AVM value using an algorithm and then adjusts the AVM value based on the adjustment value (step 325). The display device 225 (e.g., a monitor, LCD screen, LED screen, mobile device screen, etc.) displays the AVM value ($290,000), the adjustment value ($50,000) and an adjusted AVM value (e.g., $340,000) (step 330). This allows a lender to obtain a more accurate valuation of the subject property.

Several adjusted AVM values can be obtained based on the values used. For example, using the relative difference values, the adjusted AVM value is calculated to be $340,000 ($290,000+$50,000). Furthermore, by using the percentage values, the adjusted AVM value is calculated to be $362,500 ($290,000×1.25).

The keywords may not be exactly matched due to misspellings, typos, abbreviations, and variations of the keywords in the database or in the retrieving process. In one embodiment, the data mining module 215 has a fuzzy logic module to recognize keywords which are not an exact match. For example, the mismatch can arise while using optical character recognition (OCR) technology on the property data. The OCR is a mechanical or electronic translation of images of handwritten, typewritten or printed text (usually captured by a scanner) into machine-editable text including characters. The OCR can be used to read the data in the comments or remarks field 125. It is useful for converting paper books and documents into electronic files, but the characters are not always recognized correctly introducing typos and misspellings of words.

In one embodiment, the keywords may be difficult to represent through a relative difference value or a percentage difference value. For example, keywords of “tear down,” “flood damage,” or “earthquake damage” indicate properties with possibly significant adjustments. When difficult keywords are matched, a new appraisal may be requested.

The embodiments disclosed herein may be implemented entirely in the AVM, entirely separate from the AVM, or implemented between both. For example, although the AVM 220 is described as calculating the adjustment to the property value, this calculation can also be performed in a module separate from the AVM. Likewise, although the searching is described as being performed in the data mining module 215, this searching can also be performed in the AVM.

Embodiments may be performed using a processor. The processor may be implemented using hardware, software, firmware, middleware, microcode, or any combination thereof. The processor may be an Advanced RISC Machine (ARM), a controller, a digital signal processor (DSP), a microprocessor, an encoder, a decoder, or any other device capable of processing data, and combinations thereof. The term “memory” and “machine readable medium” include, but are not limited to, random access memory (RAM), flash memory, read-only memory (ROM), EPROM, EEPROM, registers, hard disk, removable disk, CD-ROM, DVD, wireless channels, and various other mediums capable of storing, containing or carrying instruction(s) and/or data. The memory may include or store various routines and data. These modules may include machine readable instructions stored in the memory, the machine readable instructions being executed by the processor to cause the processor to perform various functions as described in this disclosure.

Those skilled in the art will appreciate that the various illustrative logical blocks, modules, circuits, and algorithms described in connection with the embodiments disclosed herein may be implemented as electronic hardware, computer software, or combinations of both. To illustrate this interchangeability of hardware and software, various illustrative components, blocks, modules, circuits, and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processing device, a digital signal processing device (DSP), an application specific integrated circuit (ASIC), a field programmable gate array (FPGA) or other programmable logic device, discrete gate or transistor logic, discrete hardware components, or any combination thereof designed to perform the functions described herein. A general purpose processing device may be a microprocessing device, but in the alternative, the processing device may be any conventional processing device, processing device, microprocessing device, or state machine. A processing device may also be implemented as a combination of computing devices, e.g., a combination of a DSP and a microprocessing device, a plurality of microprocessing devices, one or more microprocessing devices in conjunction with a DSP core or any other such configuration.

The apparatus, methods or algorithms described in connection with the embodiments disclosed herein may be embodied directly in hardware, software, or combination thereof. In software the methods or algorithms may be embodied in one or more instructions that may be executed by a processing device. The instructions may reside in RAM memory, flash memory, ROM memory, EPROM memory, EEPROM memory, registers, hard disk, a removable disk, a CD-ROM, or any other form of storage medium known in the art. An exemplary storage medium is coupled to the processing device such the processing device can read information from, and write information to, the storage medium. In the alternative, the storage medium may be integral to the processing device. The processing device and the storage medium may reside in an ASIC. The ASIC may reside in a user terminal. In the alternative, the processing device and the storage medium may reside as discrete components in a user terminal.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The invention may be embodied in other specific forms without departing from its spirit or essential characteristics. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. A system for adjusting an automated valuation model (AVM) value, the system comprising:
a property data source for receiving property data for a property;
a data mining module for searching the property data for keywords with corresponding values; and
a data matching module for recognizing the keywords, for determining an adjustment value based on the corresponding values, for receiving an AVM value representing an estimated value of the property, and for obtaining an adjusted AVM value based on the AVM value and the adjustment value.

2. The system of claim 1, wherein the corresponding values is selected from at least one of a relative difference value or a percentage value.

3. The system of claim 2, wherein the relative difference value is selected from one of −$20,000, −$15,000, −$10,000, −$5,000, $5,000, $10,000, $15,000, and $20,000.

4. The system of claim 2, wherein the percentage value is selected from one of −20%, −15%, −10%, −5%, 5%, 10%, 15%, and 20%.

5. The system of claim 1, wherein the keywords comprise single words and phrases.

6. The system of claim 5, wherein the single words comprise remodeled and the phrases comprise fixer upper.

7. The system of claim 1, wherein the data matching module recognizes misspellings, typos, abbreviations, and variations of the keywords.

8. The system of claim 1, wherein the property data source comprises a real estate listing.

9. The system of claim 8, wherein the data mining module searches a comments field in the real estate listing.

10. The system of claim 1, further comprising requesting an appraisal based on the keywords that are recognized.

11. A machine-readable medium embodying a method of adjusting an automated valuation model (AVM) value, the method comprising:
receiving property data for a property;
searching the property data for keywords with corresponding values; and
recognizing the keywords;
determining an adjustment value based on the corresponding values;
receiving an AVM value representing an estimated value of the property; and
obtaining an adjusted AVM value based on the AVM value and the adjustment value.

12. The machine-readable medium of claim 11, wherein the corresponding values is selected from at least one of a relative difference value or a percentage value.

13. The machine-readable medium of claim 12, wherein the relative difference value is selected from one of −$20,000, −$15,000, −$10,000, −$5,000, $5,000, $10,000, $15,000, and $20,000.

14. The machine-readable medium of claim 12, wherein the percentage value is selected from one of −20%, −15%, −10%, −5%, 5%, 10%, 15%, and 20%.

15. The method of claim 11, wherein the keywords comprise single words and phrases.

16. The method of claim 15, wherein the single words comprise remodeled and the phrases comprise fixer upper.

17. The method of claim 11, wherein the data matching module recognizes misspellings, typos, abbreviations, and variations of the keywords.

18. The method of claim 11, wherein the property data source comprises a real estate listing.

19. The method of claim 18, wherein the data mining module searches a comments field in the real estate listing.

20. The method of claim 11, further comprising requesting an appraisal based on the keywords that are recognized.
